(19) United States
(12) Patent Application Publication
(10) Pub. No.: US 2015/0050553 A1
(43) Pub. Date: Feb. 19, 2015

(54) CELL

(71) Applicants: Dongguan Amperex Technology Limited, Dongguan (CN); Ningde Amperex Technology Limited, Ningde (CN)

(72) Inventors: Yeli Lin, Dongguan (CN); Cong Li, Dongguan (CN); Zhong Shi, Dongguan (CN); Jintao Cao, Dongguan (CN); Hongxin Fang, Dongguan (CN); Baiqing Zhang, Dongguan (CN)

(73) Assignees: Dongguan Amperex Technology Limited, Dongguan (CN); Ningde Amperex Technology Limited, Ningde (CN)

(21) Appl. No.: 14/292,489

(22) Filed: May 30, 2014

(30) Foreign Application Priority Data
Aug. 16, 2013 (CN) 201320503447.1

(51) Int. Cl. H01G 11/26; H01G 11/50; H01M 10/04

(52) U.S. Cl. CPC H01G 11/26; H01M 10/0431; H01G 11/50
USPC 429/211; 361/500

(57) ABSTRACT

The present disclosure provides a cell, which has a stacked body composed of a first electrode plate, a second electrode plate and separators, the stacked body has a starting end and a terminal end, the first electrode plate is provided with a first electrode tab, the second electrode plate is provided with a second electrode tab, the cell has a main body portion formed by winding a part of the stacked body from the starting end of the stacked body and a folded portion formed by folding the rest of the stacked body from a distal end of the main body portion over the main body portion and covering a part of the main body portion The cell can be formed as a step-shaped configuration by directly and sufficiently utilizing winding without cutting or treating the electrode plate, the manufacturing process is simple.

### CROSS-REFERENCE TO RELATED APPLICATIONS

The present application claims priority to Chinese patent application No. 201320503447.1 filed on Aug. 16, 2013, which is incorporated herein by reference in its entirety.

### TECHNICAL FIELD OF THE PRESENT DISCLOSURE

The present disclosure relates to a component of an electrochemical device, particularly relates to a cell.

### BACKGROUND OF THE PRESENT DISCLOSURE

As an arrangement of many electronic components in a mobile electronic device always appears as a step profile or other irregular profile, a space left for placing a battery is not always regular rectangular. However, most of lithium-ion batteries are regular rectangular at present, when such a lithium-ion battery is used in the mobile electronic device, a part of an inner space of the mobile electronic device is usually idle and is wasted. Therefore, the industry have proposed a step-shaped battery so as to improve efficient use of the space of the mobile electronic device from the battery, thus the mobile electronic device having the same dimension can achieve better volume and energy effects from the step-shaped battery.

A US patent application publication No. US 2012/0015236 A1, published on Jan. 19, 2012, discloses a design and construction of non-rectangular batteries in which electrode plates are arranged in a stacked configuration to facilitate efficient use of space inside a portable electronic device. International Patent Application Publication No. WO/2012/060972 A1, published on May 10, 2012, discloses a rechargeable battery with a jelly roll having multiple thicknesses (, in which different thicknesses are created by removing electrode plate material from one or more of the layers before winding the layers together. These manufacturing processes of the lithium-ion battery are very complicated, and cutting or removing with respect to the battery electrode plate mostly easily result in lots of burrs, and consequently safety performance of the battery would be affected.

### SUMMARY OF THE PRESENT DISCLOSURE

In order to resolve the problem existing in the background, an object of the present disclosure is to provide a cell, which can form a step-shaped cell by directly and sufficiently utilizing winding without cutting or treating the electrode plate, and has a simple manufacturing process.

In order to achieve the above object, the present disclosure provides a cell, which has a stacked body composed of a first electrode plate, a second electrode plate and separators, the stacked body has a starting end and a terminal end, the first electrode plate is provided with a first electrode tab, the second electrode plate is provided with a second electrode tab, the cell has a main body portion formed by winding a part of the stacked body from the starting end of the stacked body and a folded portion formed by folding the rest of the stacked body from a distal end of the main body portion over the main body portion and covering a part of the main body portion.

The present disclosure has the following beneficial effects:

The main body portion is formed by winding, then the folded portion is formed on the main body portion, the cell can be formed as a step-shaped configuration by directly and sufficiently utilizing winding without cutting or treating the electrode plate, the manufacturing process is simple.

### BRIEF DESCRIPTION OF THE FIGURES

FIG. 1 is a schematic view illustrating a provision relationship between electrode plates and separators of a cell;

FIG. 2 is a schematic perspective view of an embodiment of a cell according to the present disclosure, with separators omitted for the sake of clarity;

FIG. 3 is a schematic perspective view of another embodiment of a cell according to the present disclosure, with separators omitted for the sake of clarity;

FIG. 4 is a schematic perspective view of another embodiment of the cell according to the present disclosure, with the separator omitted for the sake of clarity;

FIG. 5 is a schematic perspective view of another embodiment of a cell according to the present disclosure, with separators omitted for the sake of clarity;

FIG. 6 is a schematic perspective view of another embodiment of a cell according to the present disclosure, with separators omitted for the sake of clarity.

Reference numerals of the embodiments are represented as follows:

| | |
|---|---|
| 1 first electrode plate | 6 second electrode tab |
| 2 second electrode plate | 7 main body portion |

| | |
|---|---|
| 3 separator | 71 surface |

| | |
|---|---|
| 4 stacked body | 8 folded portion |

| | |
|---|---|
| 41 starting end | 9 step |

| | |
|---|---|
| 42 terminal end | 91 surface |

| | |
|---|---|
| 5 first electrode tab | D folded direction |

### DETAILED DESCRIPTION

Hereinafter a cell according to the present disclosure will be described in detail in combination with the Figures.

Referring to FIGS. 1-6, a cell according to the present disclosure has a stacked body 4 composed of a first electrode plate 1, a second electrode plate 2 and separators 3, the stacked body 4 has a starting end 41 and a terminal end 42, the first electrode plate 1 is provided with a first electrode tab 5, the second electrode plate 2 is provided with a second electrode tab 6, the cell has a main body portion 7 formed by winding a part of the stacked body 4 from the starting end 41 of the stacked body 4 and a folded portion 8 formed by folding the rest of the stacked body 4 from a distal end of the main body portion 7 over the main body portion 7 and covering a part of the main body portion 7.

The first electrode plate 1 and the second electrode plate 2 may be provided with a plurality of first electrode tabs 5 and a plurality of first electrode tabs 6, respectively.

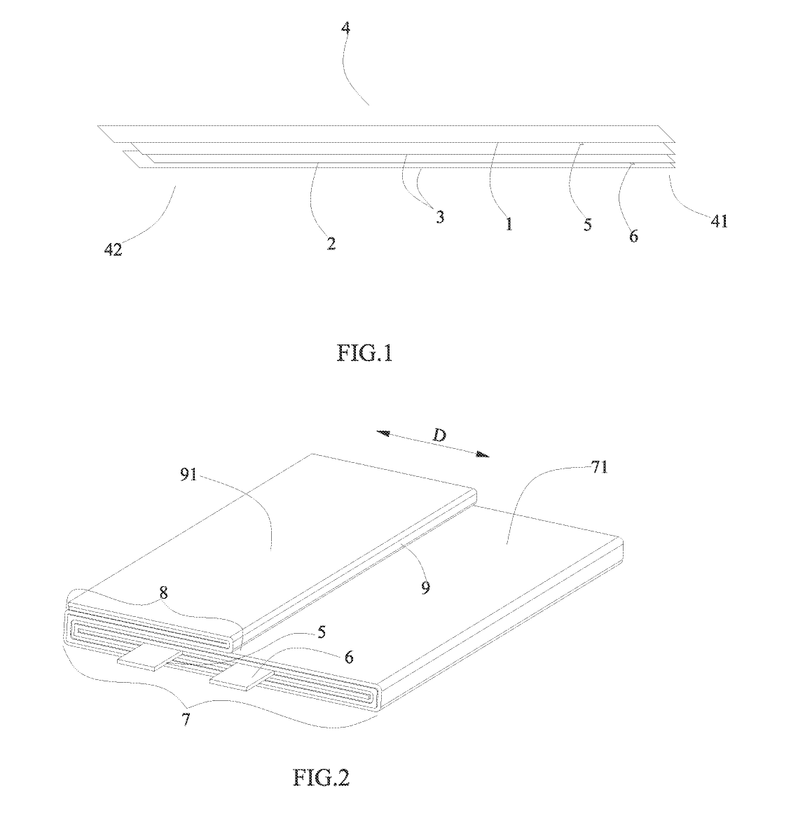

In the cell according to the present disclosure, referring to FIGS. 2-6, the folded portion 8 is formed with a step 9, the step 9 is provided as at least one in number, the step 9 is preferably provided as 1-10 in number, more preferably provided as 1-3 in number.

In an embodiment, referring to FIGS. 2-6, the folded portion 8 has at least one bent structure. The bent structure is defined as a configuration formed by rotating the letter U 90-degree clockwise or counterclockwise. Preferably, the folded portion 8 has 1-30 bent structures, and more preferably, the folded portion 8 has 1-10 bent structures.

The first electrode plate 1 and the second electrode plate 2 are collectively as an electrode plate. In an embodiment of the cell according to the present disclosure, an electrode plate positioned at an ending position of the folded portion 8 is the first electrode plate 1 or the second electrode plate 2. In another embodiment of the cell according to the present disclosure, an electrode plate positioned at an ending position of the folded portion 8 are the first electrode plate 1 and the second electrode plate 2. It should be noted that, when the electrode plate positioned at the ending position of the folded portion 8 is provided as one in number, that the one electrode plate is the first electrode plate 1 or the second electrode plate 2 can be determined according to practical situations, such as length relative relationship and materials of the two to electrode plates, and requirements for use in the electrochemical device.

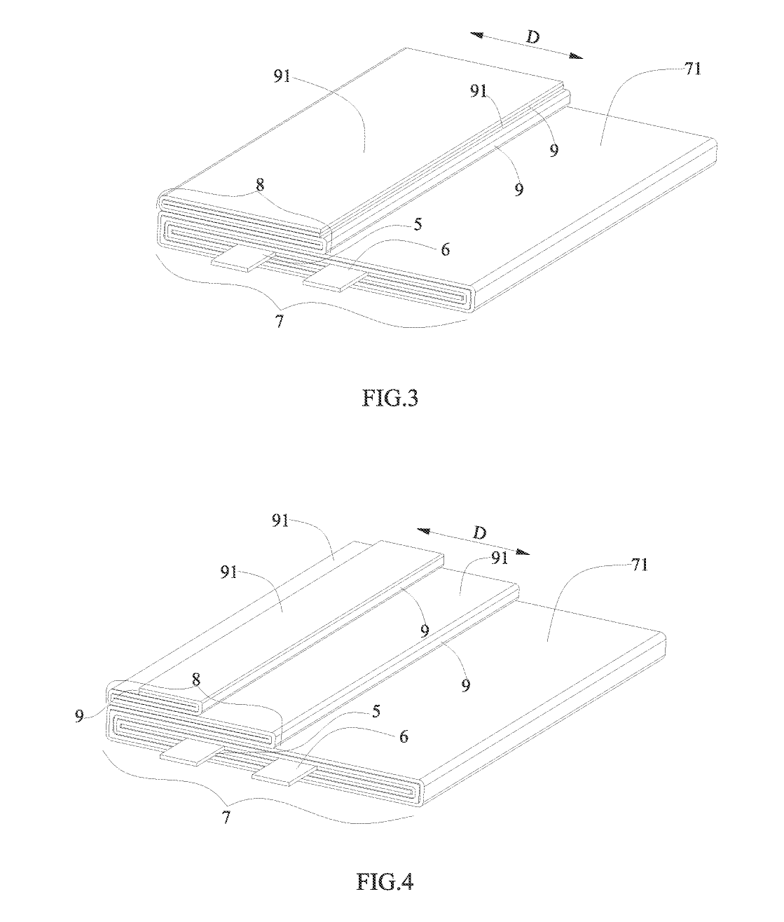

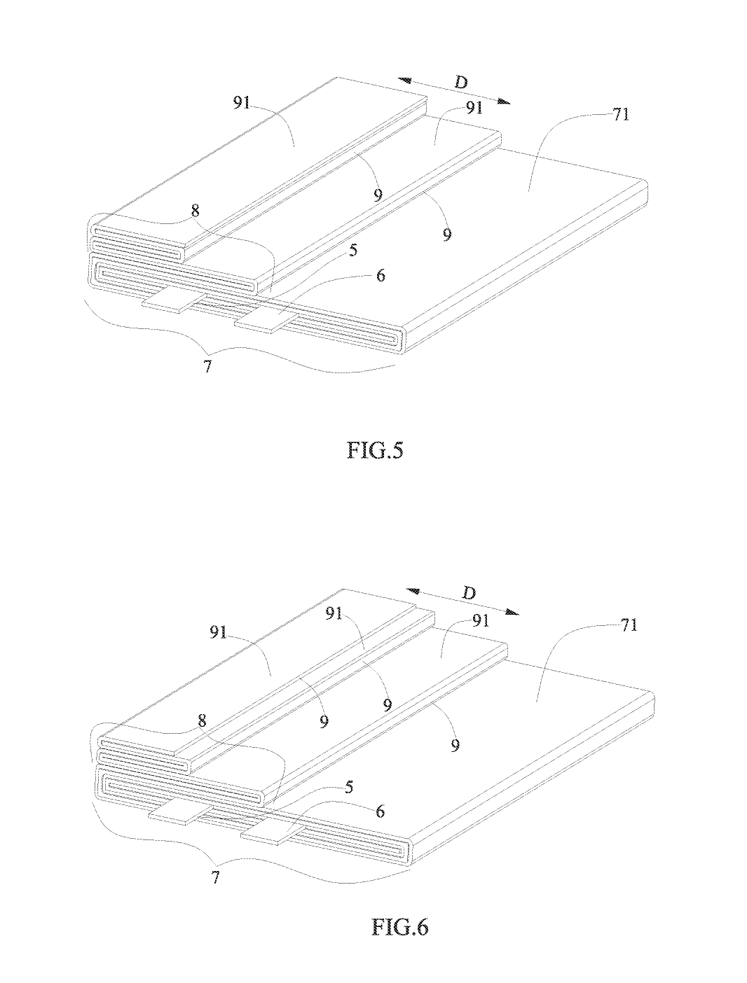

Specifically, in FIG. 2, the electrode plates positioned at the ending position of the folded portion 8 are the first electrode plate 1 and the second electrode plate 2, the folded portion 8 has the step 9 provided as one in number, the folded portion 8 has one bent structure; in FIG. 3, the electrode plate positioned at the ending position of the folded portion 8 are the first electrode plate 1 and the second electrode plate 2, the folded portion 8 has the step 9 provided as two in number, the folded portion 8 has two bent structures; in FIG. 4, the electrode plate positioned at the ending position of the folded portion 8 are the first electrode plate 1 and the second electrode plate 2, the folded portion 8 has the step 9 provided as three in number, the folded portion 8 has three bent structures; in FIG. 5, the electrode plate positioned at the ending position of the folded portion 8 is the first electrode plate 1 or the second electrode plate 2, the folded portion 8 has the step 9 provided as two in number, the folded portion 8 has four bent structures; in FIG. 6, the electrode plate positioned at the ending position of the folded portion 8 is the first electrode plate 1 or the second electrode plate 2, the folded portion 8 has the step 9 provided as three in number, the folded portion 8 has four bent structures.

In an embodiment, referring to FIGS. 3-6, when the step 9 is formed as more than two in number (two or more than two), an area of the step 9 positioned above is smaller than an area of the step 9 positioned below in the two adjacent steps 9. It should be noted that, in FIGS. 2-6, a folded direction D is indicated by a double-headed arrow to indicate bidirectional feature of the folding, namely folding from left to right and folding from right to left in the Figures.

In an embodiment, referring to FIGS. 2-6, a surface 91 of the step 9 is a flat surface, a surface 71 of the main body portion 7 is a flat surface.

In an embodiment, referring to FIGS. 2-6, the folded portion 8 may be flush with the main body portion 7 at an end side of the cell (namely at leftmost edge in FIG. 2, FIG. 3, FIG. 5, FIG. 6) or may be not flush with the main body portion 7 at an end side of the cell (namely at a leftmost edge in FIG. 4).

The cell according to the present disclosure may be a cell of a battery or a cell of a capacitor. The battery may be but not limited to a lithium-ion battery, the capacitor may be but not limited to a lithium-ion super-capacitor.

Hereinafter a manufacturing process of the cell of the present disclosure will be briefly described.

Referring to FIG. 1, the manufacturing process comprises steps of: stacking the first electrode plate 1 (welded with the first electrode tab 5), second electrode plate 2 (welded with the second electrode tab 6), and the separators 3 which have been prepared to form the stacked body 4; winding the stacked body 4 from the starting end 41 for a certain length via a winding mechanism to form the main body portion 7; folding one or more times from the distal end of the main body portion 7 along the folded direction D to form the folded portion 8 having the step 9;

flattening to fix the profile of the cell; and fixing the terminal end 42 of the stacked body 4 with such as an adhesive tape.

What is claimed is:

1. A cell, having a stacked body (4) composed of a first electrode plate (1), a second electrode plate (2) and separators (3), the stacked body (4) having a starting end (41) and a terminal end (42), the first electrode plate (1) being provided with a first electrode tab (5), the second electrode plate (2) being provided with a second electrode tab (6),
the cell having:
a main body portion (7) formed by winding a part of the stacked body (4) from the starting end (41) of the stacked body (4); and
a folded portion (8) formed by folding the rest of the stacked body (4) from a distal end of the main body portion (7) over the main body portion (7) and covering a part of the main body portion (7).

2. The cell according to claim 1, wherein the folded portion (8) is formed with a step (9) and the step (9) is provided as at least one in number.

3. The cell according to claim 2, wherein the step (9) is provided as 1-10 in number.

4. The cell according to claim 3, wherein the step (9) is provided as 1-3 in number.

5. The cell according to claim 1, wherein the folded portion (8) has at least one bent structure.

6. The cell according to claim 5, wherein the folded portion (8) has 1-30 bent structures.

7. The cell according to claim 6, wherein the folded portion (8) has 1-10 bent structures.

8. The cell according to claim 2, wherein when the step (9) is formed as more than two in number, an area of the step (9) positioned above is smaller than an area of the step (9) positioned below for the two adjacent steps (9).

9. The cell according to claim 2, wherein a surface (91) of the step (9) is a flat surface, a surface (71) of the main body portion (7) is a flat surface.

10. The cell according to claim 1, wherein the folded portion (8) is flush with the main body portion (7) at an end side of the cell.

11. The cell according to claim 1, wherein the folded portion (8) is not flush with the main body portion (7) at an end side of the cell.

12. The cell according to claim 1, wherein an electrode plate positioned at an ending position of the folded portion (8) is the first electrode plate (1) or the second electrode plate (2).

13. The cell according to claim 1, wherein an electrode plate positioned at an ending position of the folded portion (8) are the first electrode plate (1) and the second electrode plate (2).

14. The cell according to claim 1, wherein the cell is a cell of a battery or a cell of a capacitor.

15. The cell according to claim 14, wherein the battery is a lithium-ion battery, the capacitor is a lithium-ion super-capacitor.
